(19) United States
(12) Patent Application Publication
(10) Pub. No.: US 2013/0045847 A1
(43) Pub. Date: Feb. 21, 2013

(54) MACHINE FOR MAKING PACKING BOXES

(71) Applicant: Giuseppe Capoia, Cimadolmo (IT)

(72) Inventor: Giuseppe Capoia, Cimadolmo (IT)

(73) Assignee: PANOTEC SRL, Cimadolmo (IT)

(21) Appl. No.: 13/643,749

(22) PCT Filed: Apr. 26, 2011
(86) PCT No.: PCT/IB2011/000896

§ 371 Date: Oct. 26, 2012

(30) Foreign Application Priority Data
Apr. 27, 2010 (IT) UD2010A000085

(51) Int. Cl. B31B 1/25

(52) U.S. Cl. 493/59

(57) ABSTRACT

Machine for making packing boxes, by means of cutting and/or pre-creasing operations on a sheet (F) of sufficiently rigid material, comprising feed rolls (15, 16), able to move the sheet (F) forward in a first longitudinal direction (L). A first working head (21) is mobile in a transverse direction (T), substantially perpendicular to the longitudinal direction (L), in order to make transverse cuts and/or pre-creasings on the sheet (F). A group of second working heads (41) can be positioned along the transverse direction (T), in order to make longitudinal cuts and/or pre-creasings. A positioning device (75) is disposed on the first working head (21), able to cooperate with each second working head (41) in order to selectively position it in the transverse direction (T).

### FIELD OF THE INVENTION

The present invention concerns a machine for making packing boxes, both small and large, and in particular for performing cutting and pre-creasing operations on a sufficiently rigid sheet, such as for example cardboard, smooth or corrugated, plastic material or other similar materials, and thus to obtain a flat product, shaped and possibly pre-creased, that represents the development of the packing box to be produced, or at least part of it, ready to be used later so as to form the packing box itself, in a three-dimensional form. By the word sheet, here and hereafter, we mean a single sheet, or a strip, or a roll, from which a plurality of sheets can be made, having a thickness comprised between some tenths of a millimeter and some millimeters. In particular, the cutting and/or pre-creasing operations are carried out by a plurality of working heads, each provided with cutting and pre-creasing tools, some of which are positioned, either manually or automatically, in the desired positions, transverse to the direction of feed of the sheet, depending on the sizes and shape of the packing box or boxes to be made.

### BACKGROUND OF THE INVENTION

A machine for making packing boxes is known, which comprises feed rolls able to feed the sheet to be cut and/or pre-creased in a longitudinal direction, a first working head, provided with a cutting and/or pre-creasing tool, and mobile in a transverse direction, substantially perpendicular to the longitudinal direction, in order to perform transverse cuts and/or pre-creasings. A group of other working heads, each provided with a cutting and/or pre-creasing tool, is able to perform longitudinal cuts and/or pre-creasings.

The group of longitudinal working heads is guided on transverse guides, and each of them can be selectively positioned in a desired transverse position. The movement of the longitudinal working heads in the transverse direction must be performed every time that the machine has to be set so as to make a packing box different from the one made before.

In this known machine, an electric motor is combined with each longitudinal working head which, with its own toothed pinion, engaging on a fixed rack, is able to displace autonomously the corresponding longitudinal working head and to position it in the desired position.

However, the known machine has the disadvantage that it is very complex and costly, because it entails using a number of electric motors, and the relative control servo-mechanisms, the same as that of the longitudinal working heads, which at times may be more than ten.

One purpose of the present invention is to achieve a machine and a relative method to make packing boxes that not only allows to position precisely and automatically each longitudinal working head in the transverse direction, but that at the same time is simple and inexpensive.

Another purpose of the present invention is to achieve a machine and a relative method to make packing boxes that does not entail using a plurality of electric motors, to command the different longitudinal working heads.

Another purpose of the present invention is to allow a possible manual displacement of each longitudinal working head in the transverse direction.

The Applicant has devised, tested and embodied the present invention to overcome the shortcomings of the state of the art and to obtain these and other purposes and advantages.

### SUMMARY OF THE INVENTION

The present invention is set forth and characterized in the independent claims, while the dependent claims describe other characteristics of the invention or variants to the main inventive idea.

In accordance with the above purpose, a machine for making packing boxes according to the present invention allows to perform cutting and/or pre-creasing operations on a sheet of sufficiently rigid material, to obtain a flat product, shaped and possibly pre-creased, which represents the development of the packing box to be made, or at least part of it, ready to be later bent so as to form the packing box itself in three-dimensional form.

The machine according to the present invention comprises feed means able to feed the sheet in a longitudinal direction, a first working head, provided with a cutting and/or pre-creasing tool, and mobile in a transverse direction, substantially perpendicular to the longitudinal direction, in order to perform transverse cuts and/or pre-creasings, and at least a second working head, also provided with a cutting and/or pre-creasing tool, and selectively positionable in a desired position in the second transverse direction, in order to perform longitudinal cuts and/or pre-creasings.

According to a characteristic feature of the present invention, on the first working head positioning means are disposed, which are able to cooperate with the second working head in order to position it selectively in the desired transverse position.

Advantageously, the machine comprises a plurality of second working heads, each of which has the same characteristics and which can be moved by the positioning means in the transverse direction.

In particular, the first working head comprises a first slider, commanded by motor means and able to slide alternately in the two senses in the transverse direction.

Advantageously, in some forms of embodiment, the positioning means comprise at least a drawing element mounted on the slider and selectively drivable so as to engage with the second working head.

According to some forms of embodiment of the present invention, the drawing element comprises a pointed pin commanded by an actuator mounted on the first slider.

According to some forms of embodiment, the drawing element is able to cooperate with a clamping device mounted on the second working head and able to hold the latter clamped in the transverse direction.

According to some other forms of embodiment of the present invention, the motor means comprise a transmission belt commanded by a motor and having at least a rectilinear segment substantially parallel to the transverse direction.

### BRIEF DESCRIPTION OF THE DRAWINGS

These and other characteristics of the present invention will become apparent from the following description of a preferential form of embodiment, given as a non-restrictive example with reference to the attached drawings wherein:

FIG. 1 is a three-dimensional view, rear left, of a machine for making packing boxes according to the present invention;

FIG. 2 is a plane view of the machine in FIG. 1;

FIG. 3 is a rear view of the machine in FIG. 2;

FIG. 4 is a left side view of the machine in FIG. 2;

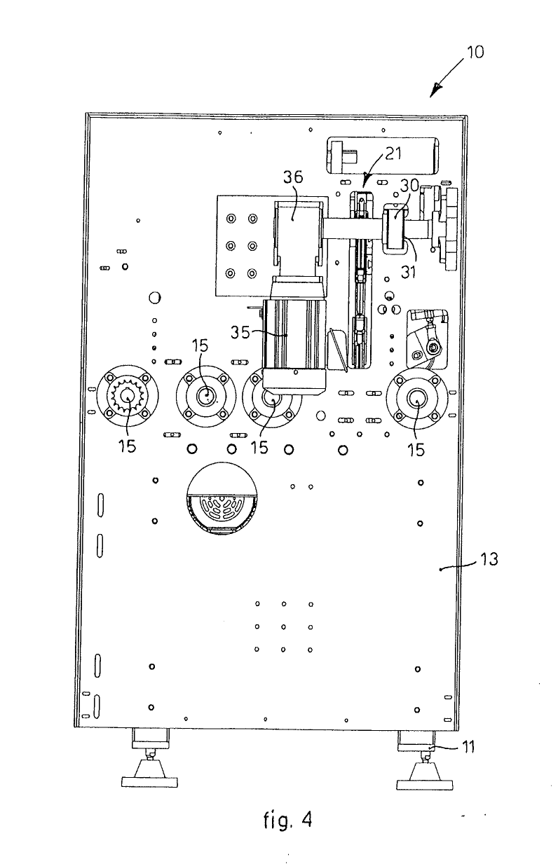

FIG. 5 is a section from V to V of FIG. 2;

FIG. 6 is an enlarged and partly sectioned detail of FIG. 5;

FIG. 7 is an enlarged detail of FIG. 6;

FIG. 8 is an enlarged detail of FIG. 1.

To facilitate comprehension, the same reference numbers have been used where possible, to identify identical common elements in the drawings.

### DETAILED DESCRIPTION OF A PREFERENTIAL FORM OF EMBODIMENT

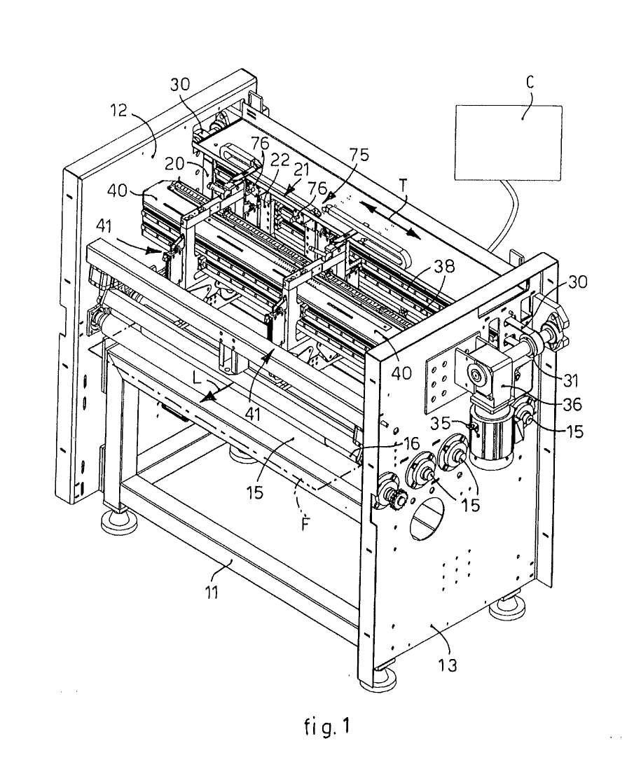

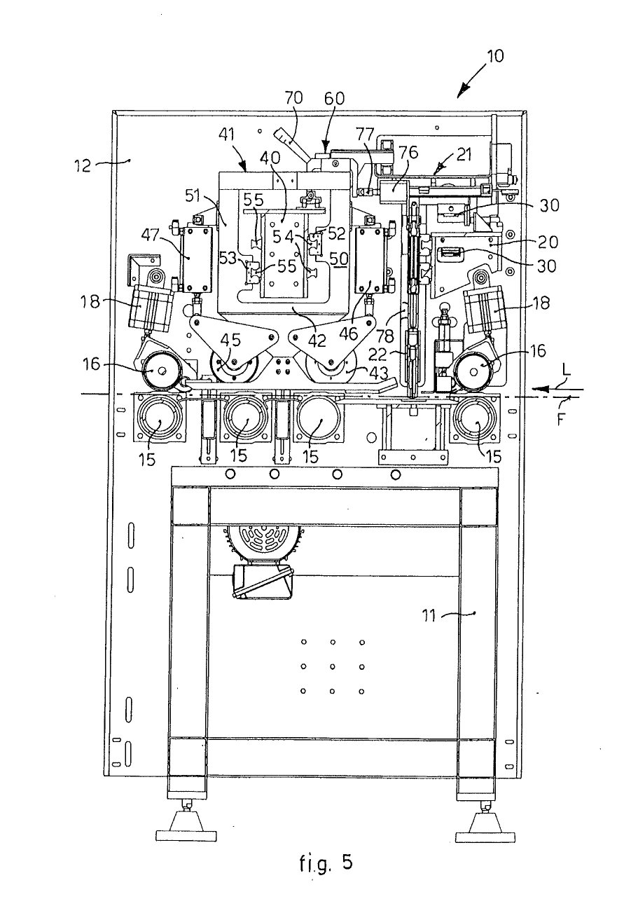

With reference to FIG. 1, a machine 10 for making packing boxes according to the present invention comprises a support frame 11 on which two lateral flanks 12 and 13 are mounted. Four feed rolls 15 are mounted on the flanks, having their axes of rotation disposed on the same horizontal plane (FIG. 5), which defines the work plane of a sheet F on which cuts and possibly pre-creasings are to be made, as will be described in more detail hereafter, so as to achieve a flat, shaped and/or pre-creased product of determinate size. Between the lateral flanks 12 and 13 several sheets F may be inserted simultaneously, adjacent to each other, so as to make several packing boxes simultaneously. The feed rolls 15 are made to rotate by an electric motor of a known type and not shown in the drawings, so as to feed the sheet or sheets F in a longitudinal direction L. Pressure rolls 16, selectively driven by actuators 18, for example pneumatic, are able to cooperate with the two outermost feed rolls 15. The rolls 15 and 16 define the feed means of each sheet

F.

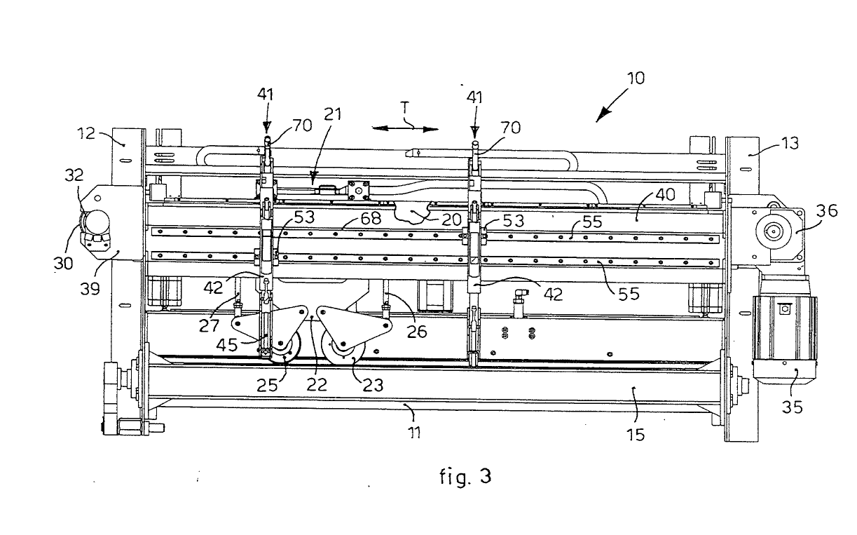

On the lateral flanks 12 and 13 (FIG. 3), above the feed rolls 15, a transverse bar 20 is attached, on which a first working head 21 is mounted sliding in a transverse direction T, perpendicular to the longitudinal direction L. The working head 21 comprises a slider 22 on which a cutting tool 23, consisting of a circular blade, and a pre-creasing tool 25, consisting of a shaped disc, are mounted. The tools 23 and 25, in a known manner, are connected to corresponding actuators 26 and respectively 27, for example pneumatic, which are able to take them selectively against each sheet F below, in order to make the transverse cuts and/or pre-creasings.

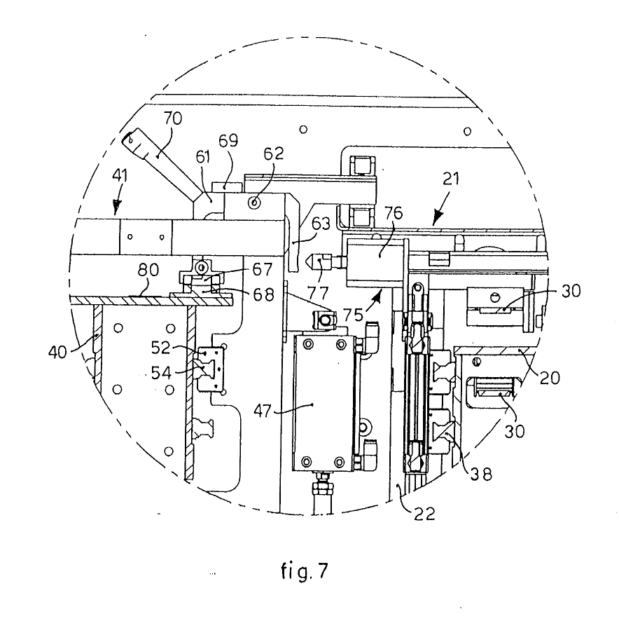

The slider 22 of the working head 21 is permanently connected to a transmission belt 30 (FIGS. 1, 2, 5 and 7), of the toothed type, which is stretched between a drive pulley 31, mounted rotatable on the external part of the lateral flank 13, and a driven pulley 32, mounted rotatable on the external flank of the lateral flank 12. The drive pulley 31 is able to be made to rotate, in two directions, by an electric motor 35, by means of a ratio-motor 36. The slider 22 is guided on a pair of guides 38 (FIG. 7) of the transverse bar 20. An angular transducer 39 (FIG. 3), associated with the driven pulley 32, is able to recognize in a known manner the position of the belt 30 and hence of the working head 21 along the transverse bar 20, and to send corresponding electric signals to a control circuit C (FIG. 1), which also controls the electric motor 35.

On the lateral flanks 12 and 13, above the feed rolls 15 and downstream of the working head 21 (FIG. 5), another transverse bar 40 is attached, on which a group of second working heads 41 are mounted sliding, only two of which are shown in the drawings. There may be multiple working heads 41, even some dozens, depending on the width of the work plane defined by the distance between the lateral flanks 12 and 13 and the number of processes to be done simultaneously on each sheet F introduced into the machine 10.

Each working head 41 comprises a slider 42 on which a cutting tool 43, also consisting of a circular blade, and a pre-creasing tool 45, also consisting of a shaped disc, are mounted. The tools 43 and 45 are connected, in a known manner, to corresponding actuators 46 and respectively 47, for example pneumatic, which are able to take them selectively against the sheet F below, in order to make longitudinal cuts and/or pre-creasings, that is, in the direction L.

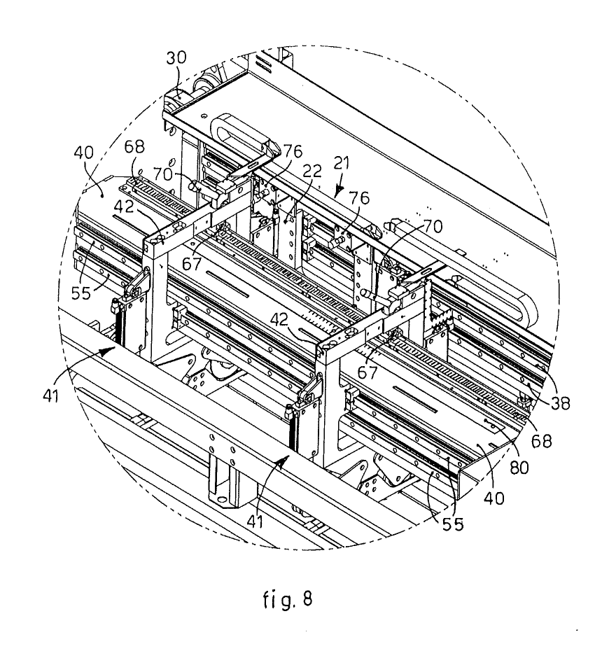

Each slider 42 is shaped so as to have a front vertical upright 50 (on the right in FIG. 5) and a rear vertical upright 51, disposed on opposite sides with respect to the transverse bar 40 and each provided with a guide pad 52, respectively 53, sliding on a corresponding horizontal guide, or rail 54, respectively 55 of the transverse bar 40. In this case, two horizontal guides 54 are provided, and two horizontal guides 55 (FIGS. 3 and 8).

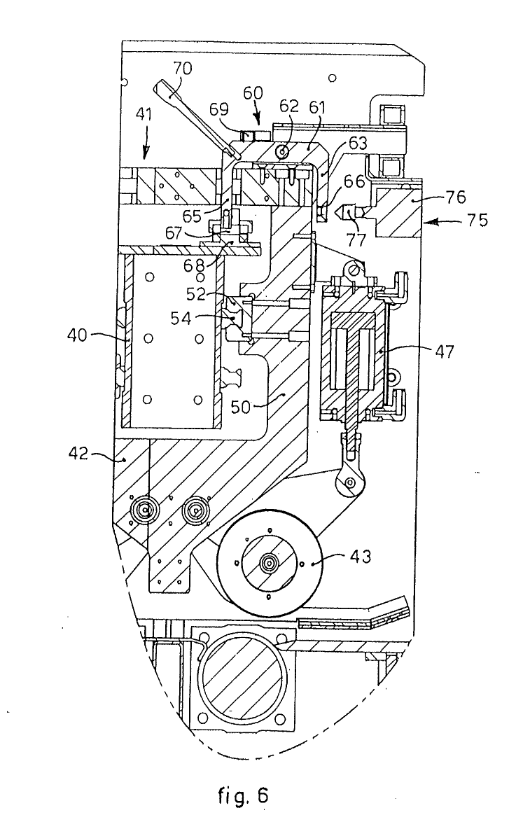

On the upper part of each slider 42 a clamping device 60 is mounted (FIGS. 5 and 6), which is able to clamp the corresponding working head 41 in the desired transverse position with respect to the transverse bar 40.

Each clamping device 60 (FIG. 6) comprises a lever 61, shaped like an upside-down “U”, which is pivoted centrally on a pin 62 of the slider 42 and comprises a front arm 63 (on the right in FIG. 6) and a rear arm 65. The front arm 63 is provided with a hole 66 with a flared entrance, able to cooperate with a positioning device or mean 75, which will be described hereafter, while the rear arm 65 is provided at the lower end with a toothed pad 67, able to cooperate with a toothed comb 68 attached on the upper surface of the transverse bar 40. A spring 69 normally holds the teeth of the toothed pad 67 inserted between the teeth of the toothed comb 68, thus keeping the corresponding working head 41 in the desired transverse position. The lever 61 is provided with a handle 70, by means of which it can be rotated manually in a clockwise direction, against the action of the spring 69, in order to release the toothed pad 67 from the toothed comb 68 and allow the slider 42 to slide on the transverse bar 40.

According to a characteristic feature of the present invention, each working head 41 can be moved automatically, instead of manually, along the transverse bar 40 and positioned in a desired position.

This is possible due to the presence of the positioning device 75 cited above, which is mounted on the slider 22 of the first working head 21.

In some forms of embodiment, which do not restrict the field of the protection of the present invention, the positioning device 75 comprises a pair of actuators 76, for example pneumatic, mounted on the rear part of the slider 22 (on the left in FIG. 7), at the sides of the latter (FIG. 8). Each actuator 76 is provided with a pointed pin 77 which functions as a drawing element, normally held in a retracted position and such as not to interfere with the arms 63 of the levers 61. During the working steps, that is, during the cutting and/or pre-creasing operations, the actuators 76 remain de-activated. A photocell 78 is mounted on the lower part of the slider 22 (FIG. 5) and is able to recognize the passage of the latter in front of each working head 41 and to send a corresponding electric signal to the control circuit C (FIG. 1), in order to identify precisely the position of each working head 41 with respect to the transverse bar 40.

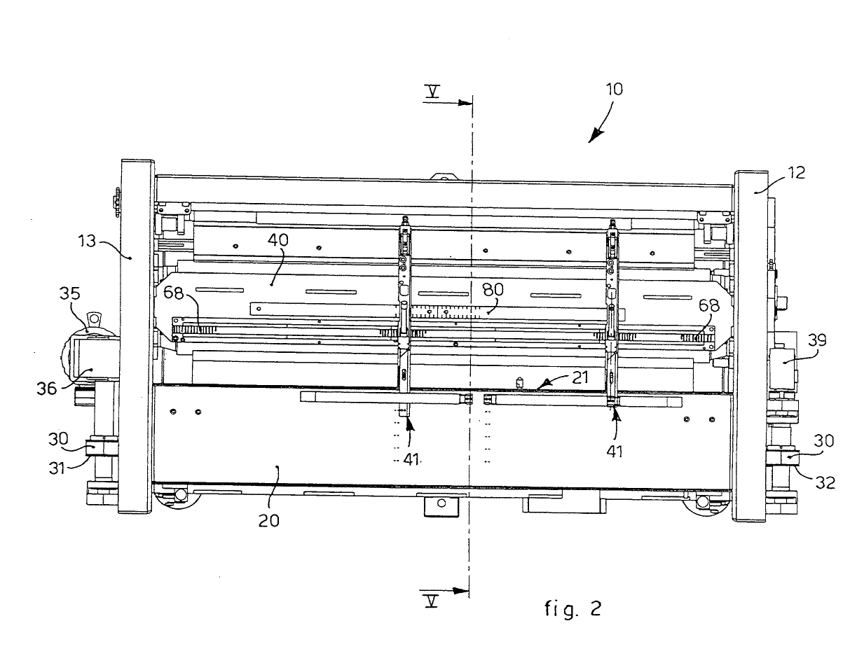

A graduated bar 80 (FIGS. 2, 7 and 8) is disposed on the transverse bar 40 to indicate visually to the operator of the machine 10 the position of each working head 41 with respect to the lateral flanks 12 and 13.

It is not excluded that, in some other forms of embodiment, the positioning device 75 is formed by or configured with different components, but equivalent in functioning to what we have described above.

The machine 10 as described heretofore functions as follows.

Firstly, the position of each working head 41 (FIGS. 2 and 3) with respect to the lateral flanks 12 and 13 and to the transverse bar 40 is programmed in a known manner by means of the control circuit C (FIG. 1), in order to make the desired longitudinal cuts and or pre-creasings on the sheet F (FIG. 5).

Each working head 41 (FIG. 3) is then moved in the transverse direction T into the desired position by means of the slider 22, driven by the motor 36 by means of the transmission belt 30.

Initially, with the tools 23 and 25 of the working head 21 raised in a non-operating position, the slider 22 is made to complete a full travel from left to right and from right to left, so that the photocell 78 (FIG. 5) acquires the necessary information on the actual position of all the working heads 41 and transmits said information to the control circuit C (FIG. 1).

Then, in order to move transversely any one of the working heads 41, the control circuit C commands the motor 35 which, by means of the transmission belt 30, causes the slider 22 to be displaced until the pointed pin 77 of one of the two actuators 76 (normally the one nearer the working head 41 to be moved) is exactly opposite the hole 66 (FIG. 6) of the corresponding lever 61. Then the actuator 76 is commanded so that its pointed pin 77 is inserted into the hole 66 and thrusts the arm 66, making the lever 61 rotate in a clockwise direction, against the action of the spring 69, thus lifting the toothed pad 65 from the toothed comb 68 below. In this condition, the slider 42 of the working head 41 is free to slide along the transverse bar 40.

Then the electric motor 35 is again commanded (FIGS. 1 and 2) which, by means of the transmission belt 30, actuates the movement of the slider 22 and of the slider 42 which is temporarily attached to it, by means of the actuator 76. This movement ends when the slider 42 and the working head 41 associated therewith arrives in the desired transverse position, calculated by the control circuit C, by means of the angular transducer 39.

The actuator 76 (FIG. 6) is then de-activated, so that its pointed pin 77 returns to the initial retracted position and also the lever 61, by means of the spring 69, returns the toothed pad 67 to cooperate with the teeth of the toothed comb 68 below. The working head 41 is thus in its desired new transverse position.

The same operation is then repeated for all the other working heads 41 that are to be moved and positioned transversely with respect to the transverse bar 40.

Once all the working heads 40 have been positioned, the machine 10 can perform on the sheet F, in a known manner, all the desired cutting and/or pre-creasing operations, both transverse, by means of the working head 21, and also longitudinal, by means of the group of working heads 41.

It should be noted that each working head 41 can not only be positioned automatically in the desired position as described above, but can also be moved manually along the transverse bar 40 by driving the corresponding handle 70.

It is clear that modifications and/or additions of parts may be made to the machine for making packing boxes as described heretofore, without departing from the field and scope of the present invention.

It is also clear that, although the present invention has been described with reference to some specific examples, a person of skill in the art shall certainly be able to achieve many other equivalent forms of machine for making packing boxes, having the characteristics as set forth in the claims and hence all coming within the field of protection defined thereby.

1. A machine for making packing boxes, by means of cutting and/or pre-creasing operations on a sheet of sufficiently rigid material, comprising: feed means able to move said sheet forward in a first longitudinal direction; a first working head, provided with a first cutting tool and/or a first pre-creasing tool and mobile in a second transverse direction, substantially perpendicular to said first longitudinal direction, in order to make transverse cuts and/or pre-creasings; at least a second working head, provided with a second cutting tool and/or a second pre-creasing tool, which can be selectively positioned in a desired position along said second transverse direction, in order to make longitudinal cuts and/or pre-creasings, wherein positioning means are disposed on said first working head, able to cooperate with said second working head in order to selectively position said second working head in said desired transverse position.

2. The machine as in claim 1, wherein said first working head comprises a first slider, commanded by motor means and sliding alternately in two directions along said second transverse direction, wherein said positioning means comprise at least a drawing element mounted on said first slider and selectively drivable to engage with said second working head.

3. The machine as in claim 2, wherein said drawing element comprises a pointed pin commanded by an actuator mounted on said first slider.

4. The machine as in claim 3, wherein said drawing element is able to cooperate with a clamping device mounted on said second working head and able to keep said second working head normally clamped along said second transverse direction.

5. The machine as in claim 4, wherein said clamping device comprises a lever normally held in a clamped position by an elastic element and wherein said drawing element is able to act on said lever so as to selectively move it into an unclamped position, against the action of said elastic element.

6. The machine as in claim 5, wherein said drawing element is able to draw said second working head along said second transverse direction, when said lever is in said unclamped position.

7. The machine as in claim 2, wherein said motor means comprise a transmission belt commanded by a motor and having at least a rectilinear segment substantially parallel to said second transverse direction.

8. The machine as in claim 1, wherein said second working head comprises a second slider, mounted sliding alternately in two directions on a transverse guide, along said second transverse direction, wherein said second slider comprises two vertical uprights, disposed on opposite sides with respect to said transverse guide and each provided with at least a guide element, sliding on a corresponding rail of said transverse guide.

9. The machine as in claims 5, wherein said lever is shaped like an upside down U, is pivoted centrally on a pin of said second slider and comprises a first arm provided with a hollow, with which said drawing element is able to cooperate, and a second arm provided with a stop element.

10. The machine as in claim 1, wherein a detection mean is mounted on said first working head, able to detect the position of said second working head along said second transverse direction.

11. A method for making packing boxes, by means of cutting and/or pre-creasing operations on a sheet of sufficiently rigid material, comprising: a step in which said sheet is made to move forward in a first longitudinal direction; a step in which transverse cuts and/or pre-creasings are made by means of a first working head, provided with a first cutting tool and/or a first pre-creasing tool and mobile in a second transverse direction, substantially perpendicular to said first longitudinal direction; a step in which longitudinal cuts and/or pre-creasings are made by means of at least a second working head, provided with a second cutting tool and/or a second pre-creasing tool, which can be selectively positioned in a desired position along said second transverse direction, wherein it provides to selectively position said second working head in said desired transverse position by means of positioning means disposed on said first working head and able to cooperate with said second working head.
